(19) United States
(12) Patent Application Publication
(10) Pub. No.: US 2013/0279755 A1
(43) Pub. Date: Oct. 24, 2013

(54) INFORMATION PROCESSING SYSTEM, INFORMATION PROCESSING METHOD, AND INFORMATION PROCESSING PROGRAM

(71) Applicant: Shuji Senda, Tokyo (JP)

(72) Inventor: Shuji Senda, Tokyo (JP)

(73) Assignee: NEC CORPORATION, Tokyo (JP)

(21) Appl. No.: 13/976,287

(22) PCT Filed: Dec. 16, 2011
(86) PCT No.: PCT/JP2011/079962

§ 371 Date: Jun. 26, 2013

(30) Foreign Application Priority Data
Dec. 27, 2010 (JP) 2010-291070

(51) Int. Cl. G06K 9/32

(52) U.S. Cl. CPC G06K 9/3241
USPC 382/103

(57) ABSTRACT

The present invention includes: a database which stores a position on a map and feature information in an image which can be taken by an imaging device at the position, to be associated with each other; an extraction means for extracting the feature information from the image; an estimation means for estimating the position at which the imaging device exists on a map on the basis of the extracted feature information referring to the database; a display means for displaying an estimated current position of the imaging device; a determination means for determining whether or not an imaging direction of the imaging device is varied by a predetermined amount from a direction in which the image from which the feature information is extracted is taken during the imaging; and a control means for controlling the extraction means so that new feature information is extracted, upon determining that the direction is varied by the predetermined amount; wherein the estimation means combines the new feature information and the extracted feature information and re-estimates the position on the map at which the imaging device exists when the new feature information is extracted.

### TECHNICAL FIELD

The present invention relates to an information processing technology to estimate an imaging position and an imaging direction.

### BACKGROUND ART

In a technology described in non-patent literature 1, three-dimensional map data and a landmark image which can be taken at each point of the three-dimensional map data are stored in a database and a comparison between an image actually taken by using an omni-directional camera and the landmark image stored in the database is performed. Further, in the technology described in non-patent literature 1, a large amount of image data are inputted at a time, current position information is calculated by using a large scale database, and it is provided to a user.

### CITATION LIST

### Non Patent Literature

NPL 1: Susuki, Nakagawa, Sato, Yokoya, “Extrinsic Camera Parameter Estimation from a Still Image Based on Feature Landmark Database”, Transactions of the Virtual Reality Society of Japan, Vol. 13, No. 2, pp. 161-170, 2008

### SUMMARY OF INVENTION

### Technical Problem

However, generally, when a user wants to know a current position, a required accuracy of position information and a required response time are different for each individual. For example, one user requires the position information with high accuracy rather than a quick response but another user requires the position information to be quickly available rather than the position information with high accuracy. However, the technology described in non-patent document 1 mentioned above cannot satisfy various user's demands. In other words, because the position information is provided without considering users 7 demands, the technology described in non-patent document 1 is not user-friendly. It is difficult to enhance capabilities of server and database in order to provide the position information at high speed for user, using the technology described in non-patent document 1

An object of the present invention is to provide technology to solve the above-mentioned problem.

### Solution to Problem

In order to achieve the above-mentioned object, a system according to the present invention includes:

a database which stores a position on a map and feature information in an image which can be taken by an imaging device at the position, to be associated with each other;

an extraction means for extracting the feature information from imaged image obtained by using the imaging device;

an estimation means for estimating the position at which the imaging device exists on a map on the basis of the feature information that is extracted in the extraction means, referring to the database;

a display means for displaying an estimated current position of the imaging device that is estimated by the estimation means;

a determination means for determining whether or not an imaging direction of the imaging device is varied by a predetermined amount from a direction in which the image from which the feature information is extracted by the extraction means is taken during the imaging by the imaging device; and

a control means for controlling the extraction means so that new feature information is extracted when the determination means determines that the imaging direction of the imaging device is varied by the predetermined amount; wherein

the estimation means combines the new feature information and the extracted feature information and re-estimates the position on the map at which the imaging device exists when the new feature information is extracted.

In order to achieve the above-mentioned object, a method according to the present invention includes:

a first extraction step of extracting feature information from an image obtained by using an imaging device;

a first estimation step of estimating a position at which the imaging device exists on a map on the basis of the feature information that is extracted in the first extraction step, upon referring to a database which stores the position on the map and feature information in the image which can be taken by the imaging device at the position, to be associated with each other;

a first display step of displaying an estimated current position of the imaging device that is estimated in the first estimation step;

a determination step of determining whether or not an imaging direction of the imaging device is varied by a predetermined amount from a direction in which the image from which the feature information is extracted in the first extraction step is taken during the imaging by the imaging device;

a second extraction step of extracting new feature information when it is determined in the determination step that the imaging direction of the imaging device is varied by the predetermined amount;

a second estimation step of re-estimating the position on the map at which the imaging device exists by combining the new feature information and the extracted feature information when the new feature information is extracted; and

a second display step of displaying the estimated current position of the imaging device that is estimated in the second estimation step.

In order to achieve the above-mentioned object, an information processing program stored in a program recording medium according to the present invention causes a computer to perform:

a first extraction step of extracting feature information from an image obtained by using an imaging device;

a first estimation step of estimating a position at which the imaging device exists on a map on the basis of the feature information that is extracted in the first extraction step, upon referring to a database which stores the position on the map and feature information in the image which can be taken by an imaging device at the position, to be associated with each other;

a first display step of displaying an estimated current position of the imaging device that is estimated in the first estimation step;

a determination step of determining whether or not an imaging direction of the imaging device is varied by a predetermined amount from a direction in which the image from which the feature information is extracted in the first extraction step is taken during the imaging by the imaging device;

a second extraction step of extracting new feature information when it is determined in the determination step that the imaging direction of the imaging device is varied by the predetermined amount;

a second estimation step of re-estimating the position on the map at which the imaging device exists by combining the new feature information and the extracted feature information when the new feature information is extracted; and

a second display step of displaying the estimated current position of the imaging device that is estimated in the second estimation step.

### Advantageous Effects of Invention

The present invention can derive position information from an imaged image and provide it to a user quickly. Further, the present invention can provide position information with high accuracy and display it to a user who requires position information with higher accuracy in a step-by-step manner by additionally obtaining feature information. Further, the present invention can easily estimate a current position of a user with a high degree of accuracy based on the feature information of the image extracted from an image of a vicinity of a user terminal.

### BRIEF DESCRIPTION OF DRAWINGS

FIG. 1 is a block diagram showing a configuration of an information processing system according to a first exemplary embodiment of the present invention.

FIG. 2 is a block diagram showing a configuration of an information processing system according to a second exemplary embodiment of the present invention.

FIG. 3 is a sequence diagram showing interaction between a user terminal and a position estimation server according to a second exemplary embodiment of the present invention.

FIG. 4A is a flowchart showing a processing procedure of a user terminal according to a second exemplary embodiment of the present invention.

FIG. 4B is a flowchart showing a processing procedure of a position-direction estimation server according to a second exemplary embodiment of the present invention.

FIG. 5 shows an example of a displayed image in which an estimated current position-direction of a user terminal according to a second exemplary embodiment of the present invention is displayed.

FIG. 6 is a block diagram showing a configuration of an information processing system according to a third exemplary embodiment of the present invention.

FIG. 7 is a block diagram showing a configuration of an information processing system according to a fourth exemplary embodiment of the present invention.

FIG. 8 is a figure illustrating a voting method of a vote section according to a fourth exemplary embodiment of the present invention.

FIG. 9 shows data of a feature information database according to a fourth exemplary embodiment of the present invention.

### EXEMPLARY EMBODIMENTS OF THE INVENTION

An exemplary Embodiment of the present invention will be described exemplarily in detail below with reference to the drawing. However, a configuration, a numerical value, a processing flow, a functional element, and the like described in the following exemplary embodiment are only examples. Therefore, modifications or changes thereof can be made without limitation and the technical scope of the present invention is not limited to the following description.

### First Exemplary Embodiment

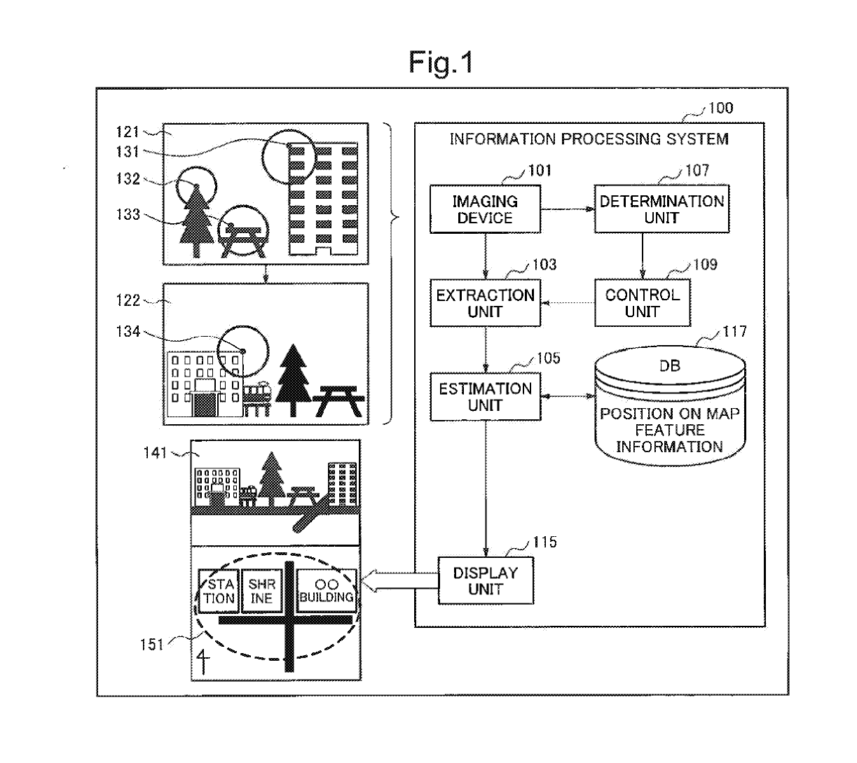

An information processing system 100 according to a first exemplary embodiment of the present invention will be described by using FIG. 1.

FIG. 1 is a block diagram showing a configuration of the information processing system 100 according to this exemplary embodiment.

As shown in FIG. 1, the information processing system 100 includes an imaging device 101, an extraction unit 103, an estimation unit 105, a determination unit 107, a control unit 109, a display unit 115, and a database 117 and estimates a current position of the imaging device 101.

The database 117 stores a position on a map and feature information included in an image which can be taken by the imaging device 101 at the position on the map, to be associated with each other. The extraction unit 103 extracts feature information 131 to feature information 133 from an image 121 taken by the imaging device 101. The estimation unit 105 refers to the database 117 and estimates the position on the map at which the imaging device 101 exists on the basis of the feature information 131 to 133 extracted by the extraction unit 103.

The display unit 115 displays an estimated existence position 151 of the imaging device 101 that is estimated by the estimation unit 105. The display unit 115 may display on a map image 141 the estimated existence position 151 of the imaging device 101 that is estimated by the estimation unit 105.

The determination unit 107 determines whether or not an imaging direction of the imaging device 101 is varied by a predetermined amount from a direction in which the image 121 from which the feature information 131 to 133 are extracted by the extraction unit 103 is taken during the imaging by the imaging device 101.

When it is determined by the determination unit 107 that the imaging direction of the imaging device 101 is varied by the predetermined amount, the control unit 109 controls the extraction unit 103 so that new feature information 134 is extracted once again. When the new feature information 134 is extracted, the estimation unit 105 combines the new feature information 134 and the feature information 131 to 133 that have already been extracted and estimates the position on the map at which the imaging device 101 exists again. The display unit 115 displays the estimated existence position 151 of the imaging device 101 that is estimated by the estimation unit 105 again. The display unit 115 may display the estimated existence position 151 of the imaging device 101 that is estimated by the estimation unit 105 again in the map image 141.

By the above mentioned configuration and operation, by using this exemplary embodiment, a current position of a user can be easily estimated with a high degree of accuracy based on the feature information extracted from an image of a vicinity of the imaging device 101.

### Second Exemplary Embodiment

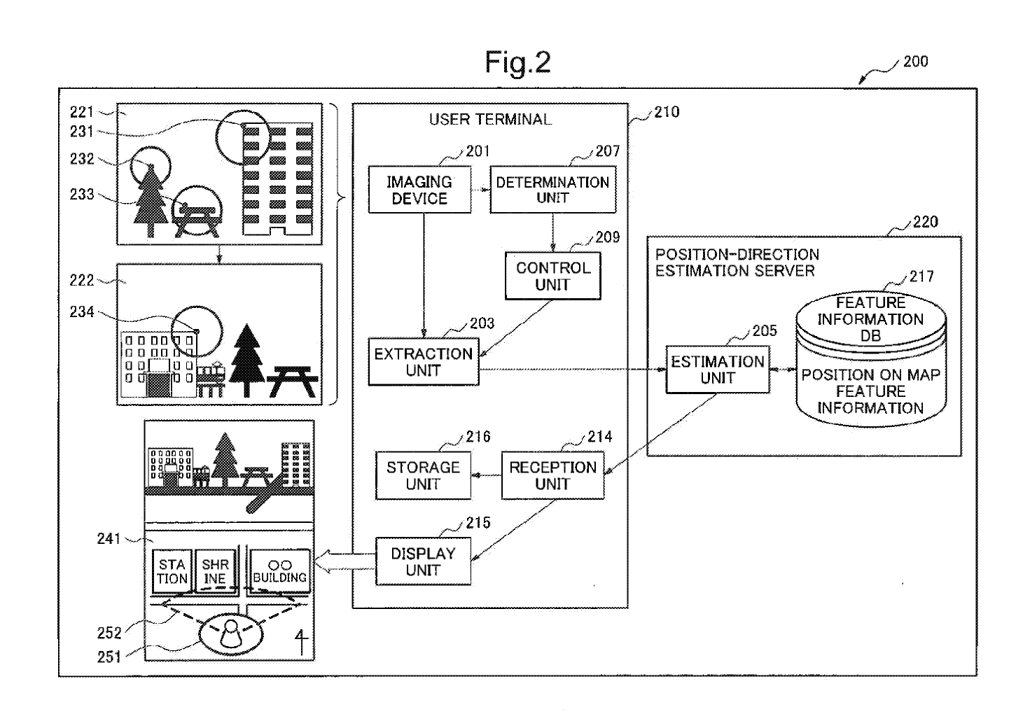

An information processing system 200 according to a second exemplary embodiment of the present invention will be described by using FIG. 2.

FIG. 2 is a block diagram showing a configuration of the information processing system 200 according to the second exemplary embodiment of the present invention. As shown in FIG. 2, the information processing system 200 includes a user terminal 210 and a position-direction estimation server 220. The user terminal 210 includes an imaging device 201, an extraction unit 203, a determination unit 207, a control unit 209, a reception unit 214, a display unit 215, and a storage unit 216.

The position-direction estimation server 220 includes an estimation unit 205 and a feature information database 217.

The imaging device 201 performs an imaging process and acquires an imaged image 221. The extraction unit 203 extracts feature information 231 to feature information 233 from the imaged image 221 and transmits them to the estimation unit 205 of the position-direction estimation server 220. Here, the feature information includes a shape of a figure included in the imaged image and information representing the position.

The feature information database 217 stores the position on the map, a direction centering around the position, and the feature information included in the image which can be taken in the direction centering around the position on the map, to be associated with each other.

The estimation unit 205 receives the feature information extracted by the extraction unit 203, refers to the feature information database 217, and estimates the position on the map at which the imaging device 201 exists and the imaging direction in which the image is taken by the imaging device 201.

When the reception unit 214 receives an estimated current position 251 and an estimated imaging direction 252 of the imaging device 201, the reception unit 214 notifies the display unit 215 or the storage unit 216 of them.

The display unit 215 displays the estimated current position 251 and the estimated imaging direction 252 of the imaging device 201 that are acquired from the reception unit 214 in a map image 241.

The determination unit 207 determines whether or not the imaging direction of the imaging device 201 is varied by a predetermined amount from the direction in which the extracted image 221 is taken during the imaging by the imaging device 201. For example, the determination unit 207 may set coordinate axes whose origin is a center of the image (reference image) that is taken first and determine an amount of variation in the imaging direction based on a variation of the coordinate of the center point of the image taken newly from the origin. Further, for example, when it is detected by an electronic compass installed in the imaging device 201 that the imaging direction is varied by a predetermined angle (for example, 10 degrees), the determination unit 207 may determine that the imaging direction is varied by the predetermined amount. Further, when by comparing the reference image with the image (new image) that is taken newly, it is detected by the determination unit 207 that an image area not included in the reference image increases by a predetermined rate (for example, 10%) in the new image, it may be determined by the determination unit 207 that the imaging direction is varied by the predetermined amount.

Further, the determination unit 207 may determine the amount of the variation in the imaging direction by using a method using a deformation matching between the images, a method by which a movement of the imaging device is obtained by an optical flow or an acceleration sensor and accumulated, or the like.

When it is determined by the determination unit 207 that the imaging direction of the imaging device 201 is varied by the predetermined amount, the control unit 209 controls the extraction unit 203 so that new feature information 234 is extracted once again. When the extraction unit 203 extracts the new feature information 234, the estimation unit 205 combines the new feature information 234 and the feature information 231 to 233 that have already been extracted and estimates the position on the map at which the imaging device 201 exists and the imaging direction again.

Further, the determination unit 207 may determine whether or not a ratio of a size of an object imaged in the reference image to a size of the whole image varies more than a predetermined amount (for example, 10% of the whole image) when the imaging device is zoomed in or out. In this case, when the imaging device 201 is zoomed in or out and by this, the amount of the variation of the imaged image exceeds a predetermined amount, the control unit 209 may control the extraction unit 203 so that the new feature information is extracted.

The reception unit 214 receives the position on the map of the imaging device 201 and the imaging direction that are estimated again from the estimation unit 205 and notifies the display unit 215 or the storage unit 216 of them.

The display unit 215 displays the position on the map of the imaging device 201 and the imaging direction that are estimated again in the map image 241.

When an estimated likelihood of the estimated existence position-direction exceeds a predetermined value or a user issues an instruction, the storage unit 216 stores the estimated existence position-direction.

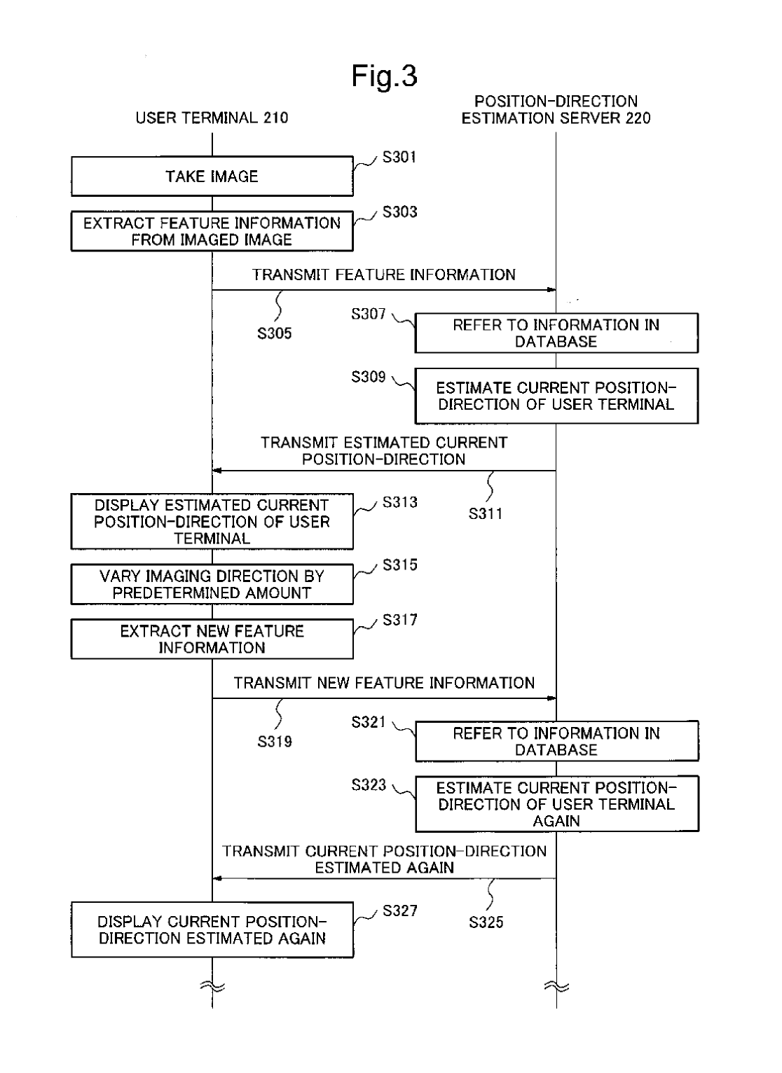

FIG. 3 is a sequence diagram showing interaction between the user terminal 210 and the position-direction estimation server 220 according to this exemplary embodiment. In step S301, the imaging device 201 takes an image and acquires the imaged image. The extraction unit 203 extracts the feature information 231 to 233 of the imaged image in step S303, and transmits the extracted feature information to the estimation unit 205 of the position-direction estimation server 220 in step S305.

In step S307, the estimation unit 205 estimates a position/direction on the map of the imaging device 201 on the basis of the received feature information, and the position on the map and the feature information associated with the position on the map that are stored in the feature information database 217. In step S309, the estimation unit 205 transmits the position/direction on the map of the imaging device 201 that is estimated, to the reception unit 214 of the user terminal 210.

When the display unit 215 acquires the position/direction on the map of the imaging device 201 from the reception unit 214, the display unit 215 displays the image indicating an estimated current position-direction of the user terminal 210 in step S313.

In step S315, the determination unit 207 determines whether or not the imaging direction is varied by a predetermined amount from a direction in which the image from which the feature information is extracted is taken. When it is determined that the imaging direction is varied by the predetermined amount, in step S317, the control unit 209 controls the extraction unit 203 so that the new feature information is extracted from the new imaged image. In step S319, the extraction unit 203 transmits the new feature information to the position-direction estimation server. The estimation unit 205 refers to the feature information stored in the feature information database 217 in step S321. The estimation unit 205 associates the feature information which has already been extracted with the new feature information and estimates the position/direction on the map of the imaging device 201 again in step S323. The estimation unit 205 transmits the position/direction on the map of the imaging device 201 that is estimated again in step S325 to the reception unit 214 of the user terminal 210.

When the display unit 215 acquires the position/direction on the map of the imaging device 201 that is estimated again on the basis of the reception unit 214, the display unit 215 displays the image indicating the estimated current position and direction of the user terminal 210 in step S327.

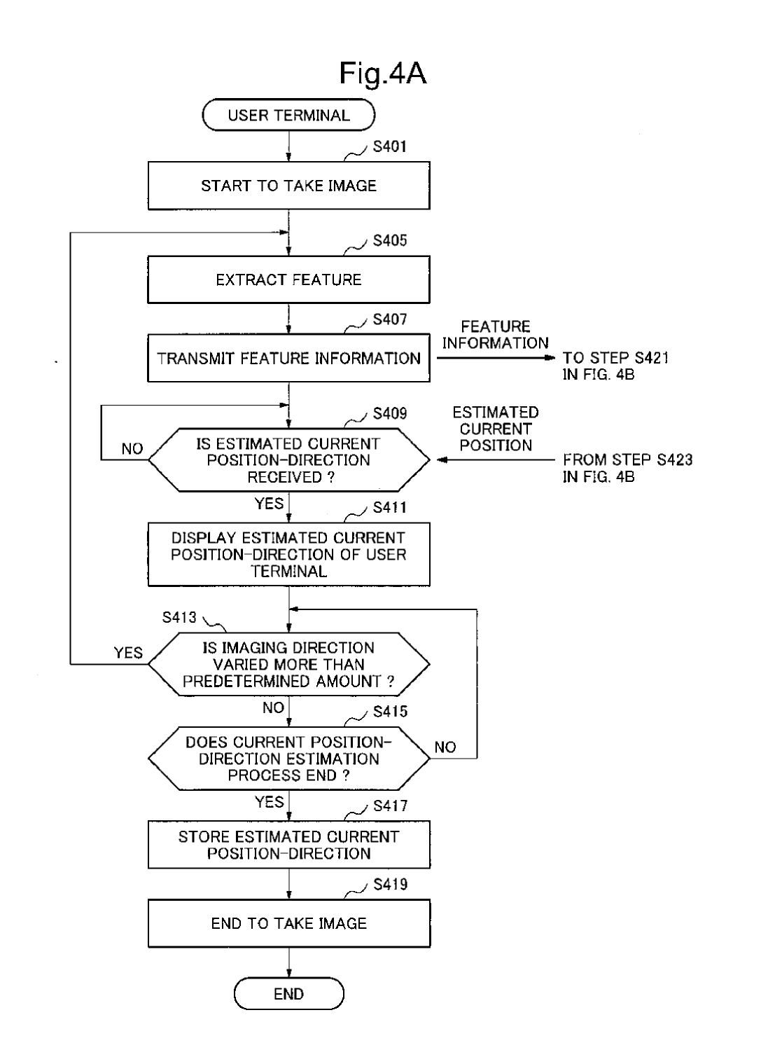

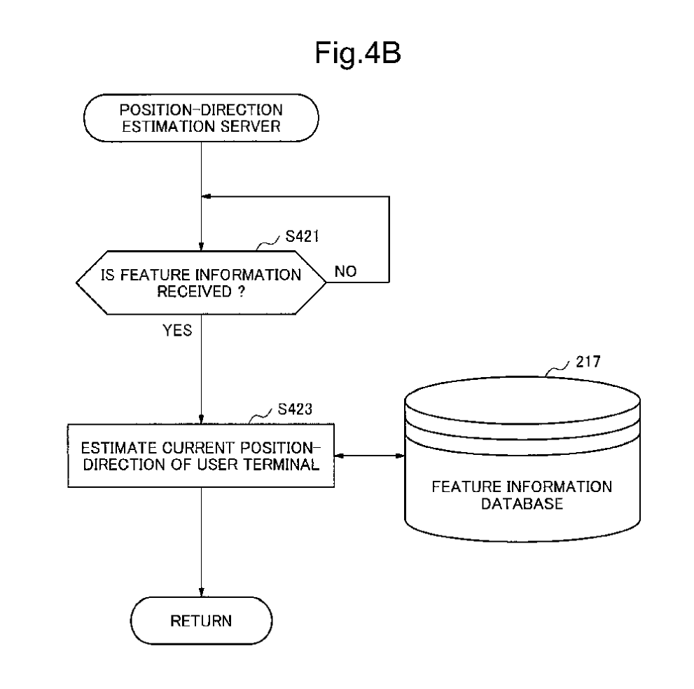

FIG. 4A is a flowchart showing the processing procedure of the user terminal 210 according to the exemplary embodiment. As current position-direction estimation process is started, the imaging device 201 starts to take an image in step S401. Next, the extraction unit 203 extracts the feature information from the imaged image 221 in step S405 and transmits the feature information to the position-direction estimation server 220 in step S407. Next, when the reception unit 214 receives the estimated current position-direction of the user terminal 210 from the position-direction estimation server 220 in step S409, the display unit 215 displays the estimated current position-direction of the user terminal 210 acquired from the reception unit 214 in step S411.

In step S413, the determination unit 207 determines whether or not the imaging direction of the imaging device 201 is varied by the predetermined amount. When it is determined that the imaging direction is varied by the predetermined amount, the process proceeds to step S405, and the control unit 209 controls the extraction unit 203 so that the new feature information is extracted. In step S415, when the control unit 209 ends the process for estimating the current position-direction of the imaging device 201, the process proceeds to step S417.

In step S417, the storage unit 216 of the user terminal stores the estimated current position-direction of the user terminal 210. Next, the process proceeds to step S419 and when the imaging device 201 ends the imaging process, the user terminal 210 ends the process for estimating the position-direction.

FIG. 4B is a flowchart showing the processing procedure of the position-direction estimation server 220 according to the exemplary embodiment. In Step S421, the estimation unit 205 receives the feature information 231 to 233 of the imaged image 221 from the extraction unit 203 of the user terminal 210. In step S423, the estimation unit 205 searches for the feature information which accords with the received feature information in the feature information database 217 and estimates the stored feature information and the position/direction on the map of the imaging device 201. Further, whenever the estimation unit 205 receives the new feature information, the estimation unit 205 repeats the estimation of the position-direction.

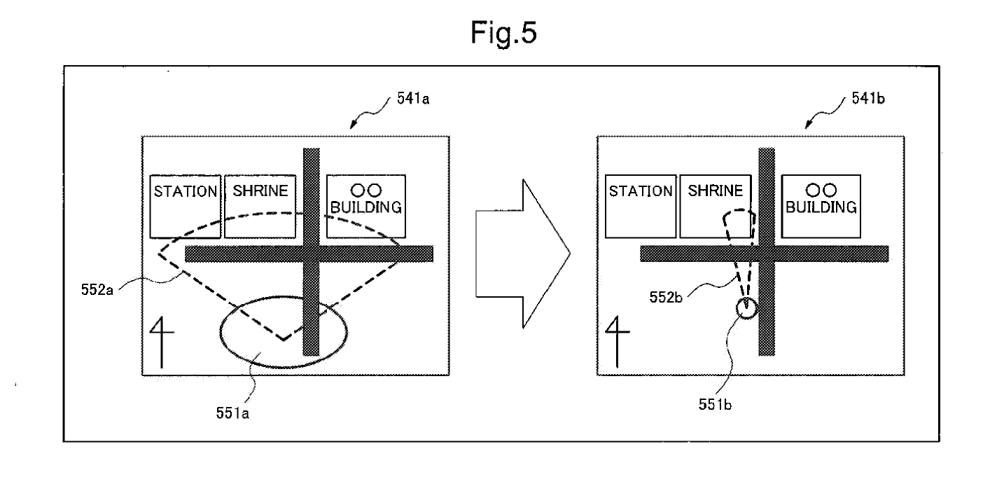

FIG. 5 shows displayed images 541a and 541b indicating the estimated current position-direction.

The displayed images 541a and 541b are the images indicating the estimated current position-direction of the user terminal 210.

The displayed image 541a is an image in which the estimated current position-direction of the imaging device 201 is shown in the map. In an image of the displayed image 541a, an estimated current position 551a of the imaging device 201 is shown by a circle whose size corresponds to the likelihood of the estimation. When the estimated current position of the imaging device 201 is not precisely estimated by the estimation unit 205, the display unit 215 displays the estimated current position 551a by a large circle.

Next, in the displayed image 541a, the estimated imaging direction of the imaging device 201 is displayed as a sector whose center angle is varied according to the likelihood of the estimation. When the estimated imaging direction of the imaging device 201 is not precisely estimated by the estimation unit 205, the display unit 215 displays the estimated imaging direction 552a as the sector whose center angle is large.

When the estimated current position-direction of the imaging device 201 is precisely estimated by the estimation unit 205, the display unit 215 displays an estimated current position 551b of the imaging device 201 as a small circle and displays an estimated imaging direction 552b of the imaging device 201 as the sector whose center angle is small as shown by the displayed image 541b.

By the above mentioned configuration and operation, by using the exemplary embodiment, the current position of the user terminal and the imaging direction can be easily estimated with a high degree of accuracy based on the feature information on the image extracted from an image of a vicinity of the imaging device.

Specifically, in the second exemplary embodiment of the present invention, a variation in the imaging direction of the imaging device is detected, new feature information is repeatedly extracted, and it is additionally used for position estimation. As a result, a wide range of area that is wider than an area of an image taken by a single shot of a camera can be used for the position estimation. Therefore, when the second exemplary embodiment of the present invention is used, because the wide range of area can be used for the position-direction estimation like the comparison using a panoramic image, the position-direction estimation with a high degree of accuracy can be realized. Further, in the second exemplary embodiment of the present invention, only the area of the image that is newly taken according to the variation in the direction of the camera is processed and only the new feature information is transmitted to the server. Therefore, in the second exemplary embodiment of the present invention, an amount of information which has to be processed at a time and a volume of communication between the terminal and the server can be reduced in comparison with a case in which a panoramic image is created. As a result, in the second exemplary embodiment of the present invention, a response speed can be made high. Further, in the second exemplary embodiment of the present invention, the estimation result of the position-direction is presented to a user and only when the user wants higher accuracy, the imaging by the camera can be continued. Therefore, in the second exemplary embodiment of the present invention, the accuracy of estimation of the position-direction can be gradually increased. Accordingly, it is not required to take an image for a long time unnecessarily.

### Third Exemplary Embodiment

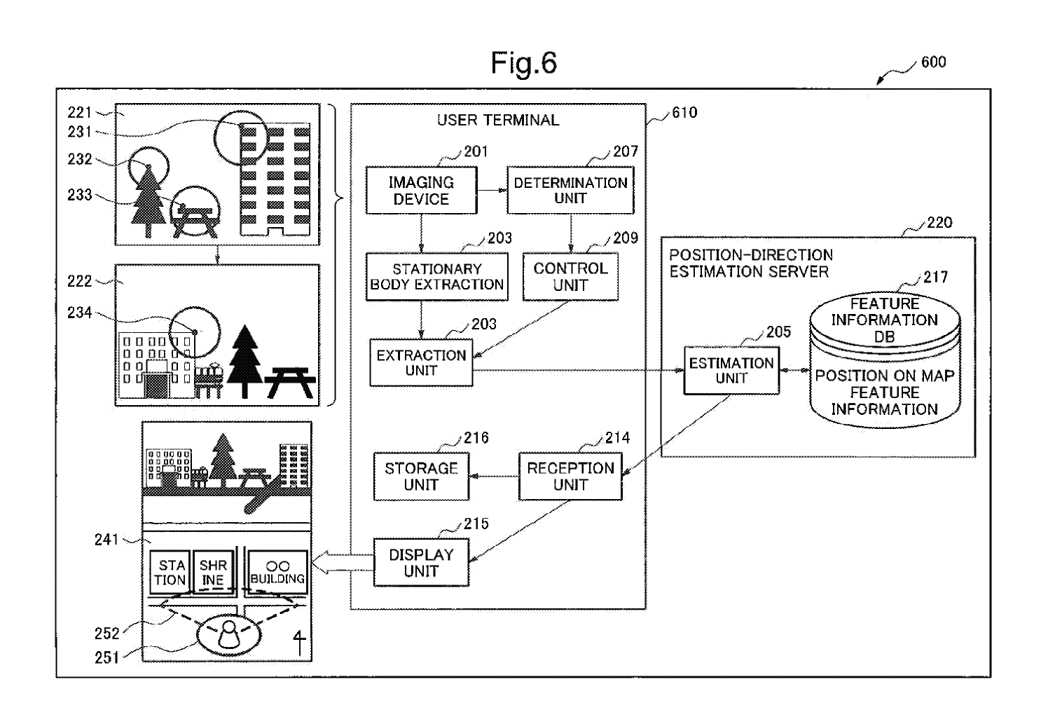

An information processing system according to a third exemplary embodiment of the present invention will be described by using FIG. 6. FIG. 6 is a block diagram showing a configuration of an information processing system 600 of this exemplary embodiment.

The configuration of the information processing system 600 includes the position-direction estimation server 220 as well as the configuration of the second exemplary embodiment. However, a user terminal 610 includes a stationary body extraction unit 606 in addition to the components included in the configuration of the second exemplary embodiment shown in FIG. 2.

The stationary body extraction unit 606 discriminates a first image area in which a moving body in the image is taken from a second image area in which a stationary body is taken and provides only the second image area to the extraction unit 203. The configuration and the operation of this exemplary embodiment are the same as those of the second exemplary embodiment besides those mentioned above. Therefore, the description will be omitted.

By the above mentioned configuration and operation, by using this exemplary embodiment, the user's current position-direction can be easily estimated with a high degree of accuracy based on the feature information included in the imaged image which is extracted from an image of a vicinity of the imaging device and in which the moving body is not included.

### Fourth Exemplary Embodiment

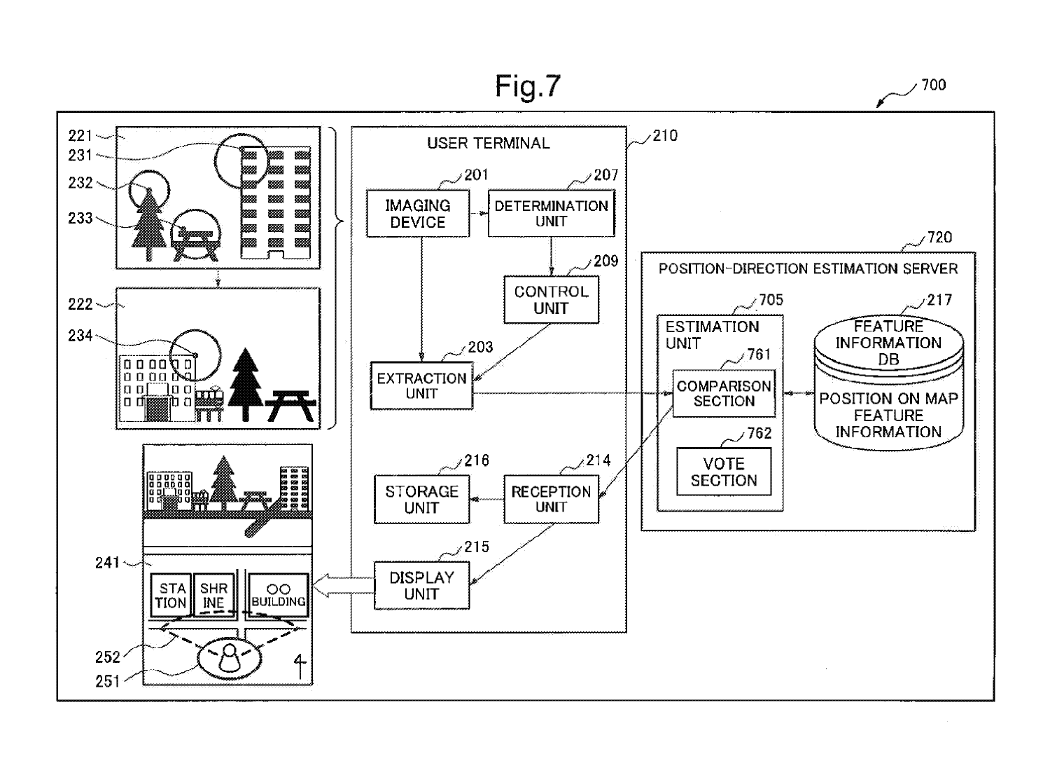

An information processing system 700 according to a fourth exemplary embodiment of the present invention will be described by using FIG. 7. FIG. 7 is a block diagram showing a configuration of the information processing system 700 of this exemplary embodiment.

The information processing system 700 includes the user terminal 210 as well as the configuration of the second exemplary embodiment. However a position-direction estimation server 720 has an estimation unit 705 including a comparison section 761 and a vote section 762.

The comparison section 761 compares the position on the map and the feature information that are stored in the feature information database 217 with the feature information of the image extracted by the extraction unit 203. Further, the vote section 762 searches for the position on the map and the feature information that are stored in the feature information database 217 similar to the feature information extracted by the extraction unit 203. The vote section 762 votes on the feature information found by the search. The vote section 762 repeats the voting with respect to all the extracted feature information.

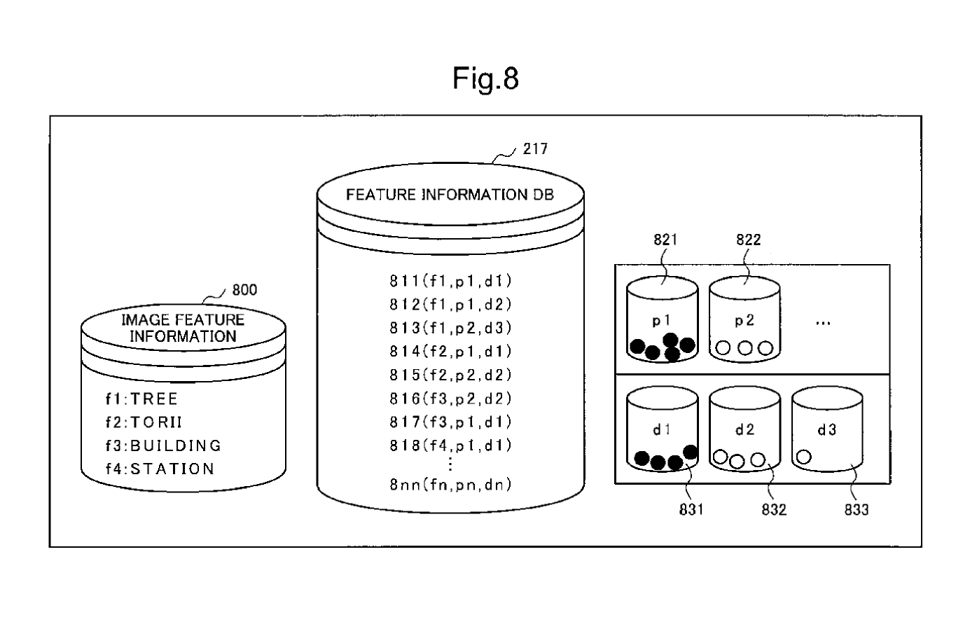

FIG. 8 shows the voting by the vote section 762.

Image feature information 800 includes image feature information f1 to f4 that are extracted. The feature information database 217 stores a candidate 811 for vote to a candidate 8nn for vote that are used for estimating the position on the map of the imaging device 201, each of which includes a position p on a map, feature information f included in an image which can be taken, and associated with the position p and stored, and an imaging direction d. A ballot for voting for the position p on the map is dropped into ballot boxes 821 and 822 and a ballot for voting for the imaging direction d is dropped into ballot boxes 831 to 833.

The vote section 762 votes on the position p on the map and the imaging direction d and votes on the candidate 811 for vote to the candidate 8nn for vote that are combined with the image feature information fn and stored in the feature information database 217. By this voting, the estimated current position of the imaging device 201 and the direction are estimated.

Specifically, the voting flow will be described. The tree of the feature information f1 of the image feature information 800 corresponds to the feature information 231 shown in FIG. 6. Similarly, the torii (an archway to a Shinto shrine) of the feature information f2 corresponds to the feature information 232, the building of the feature information f3 corresponds to the feature information 233, and the station of the feature information f4 corresponds to the feature information 234. The vote section 762 votes so that the position p1 and the position p2 that are combined with the image feature information f1 and stored in the candidate 811 for vote to the candidate 813 for vote receive two votes and one vote, respectively. Similarly, the vote section 762 votes with respect to the image feature information f2 to f4. The vote section 762 votes so that the position p1 and the position p2 receive three votes and two votes, respectively.

Similarly, the vote section 762 votes with respect to the directions d (direction d1, direction d2 and direction d3) that are combined with the feature information f2 to f4 and stored in the candidate 811 for vote to the candidate 818 for vote. The vote section 762 votes so that the direction d1, the direction d2, and the direction d3 receive four votes, three votes, and one vote, respectively.

As a result of voting, the position p1 receives five votes and the position p2 receives three votes. The position p1 receives the most votes. The estimation unit 705 estimates that the position on the map of the imaging device 201 is the position p1 with the most votes. Similarly, the vote section 762 votes so that the direction d1 receives four votes, the direction d2 receives three votes, and the direction d3 receives one vote. The estimation unit 705 estimates that the estimated imaging direction of the imaging device 201 is the direction d1 with the most votes. The other information such as an imaging altitude or the like may be added as the candidate for vote of estimating the position of the imaging device 201 and the imaging direction.

Further, the display unit 215 may vary the size of the circle of a sign 251 indicating the estimated current position p1 at which the user terminal 210 exists depending on the number of votes. Further, the display unit 215 may vary the center angle of the sector of a sign 252 indicating the imaging direction.

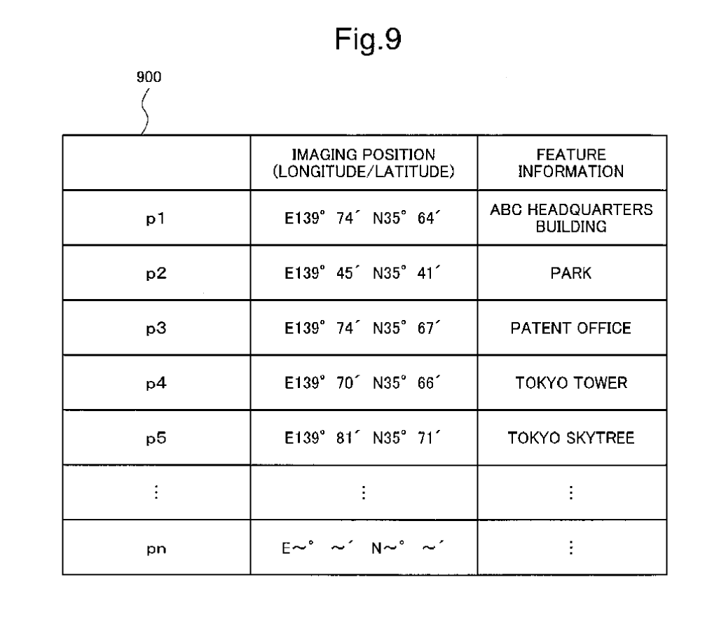

FIG. 9 shows a database of the position p on the map.

The positions p1 to pn on the map are shown by latitude and longitude. Longitude of the position p1 is 139 degrees, 74 minutes E and latitude of the position p1 is 35 degrees, 64 minutes N. The feature information “ABC headquarters building” is associated with the position p1 on the map and stored. Similarly, the database also stores latitude/longitude and the feature information that is associated with the position with respect to the position p2 to the position pn.

Further, the imaging direction may be shown as a numerical value of an angle that is measured clockwise from 0 degree (north) to 360 degrees or expressed as an azimuth angle.

By the above mentioned configuration and operation, by using the exemplary embodiment, a technology by which a current position of a user and a direction can be easily estimated with a high degree of accuracy based on the feature information included in the imaged image which is extracted from an image of a vicinity of the imaging device and in which the moving body is not included can be provided.

### Other Exemplary Embodiment

The exemplary embodiment of the present invention has been described in detail above. A system or a device in which the features of the exemplary embodiments mentioned above are arbitrarily combined is included in the scope of the present invention.

Further, the present invention may be applied to not only a system composed of a plurality of apparatuses but also a stand-alone device. Further, the present invention can be applied to a case in which an information processing program for realizing the function of the exemplary embodiment is directly or remotely provided to the system or the device. Accordingly, a program installed in a computer in order to realize the function of the present invention by the computer, a medium which stores the program, and a WWW (World Wide Web) server which downloads the program are included in the scope of the present invention.

### Other Expression of the Exemplary Embodiment

A part of or all of the above-mentioned exemplary embodiment can be described as the following note. However, the present invention is not limited to the following note.

(Note 1) An information processing system comprising:

a database which stores a position on a map and feature information in an image which can be taken by an imaging device at the position, to be associated with each other;

an extraction means for extracting the feature information from imaged image obtained by using the imaging device;

an estimation means for estimating the position at which the imaging device exists on a map on the basis of the feature information that is extracted in the extraction means, referring to the database;

a display means for displaying an estimated current position of the imaging device that is estimated by the estimation means;

a determination means for determining whether or not an imaging direction of the imaging device is varied by a predetermined amount from a direction in which the image from which the feature information is extracted by the extraction means is taken during the imaging by the imaging device; and

a control means for controlling the extraction means so that new feature information is extracted when the determination means determines that the imaging direction of the imaging device is varied by the predetermined amount; wherein

the estimation means combines the new feature information and the extracted feature information and re-estimates the position on the map at which the imaging device exists when the new feature information is extracted.

(Note 2) The information processing system according to note 1, wherein

the database stores the position on the map, a direction centering around the position, and the feature information included in the image which can be taken at the position on the map in the direction viewed from the position, to be associated with each other, and

the estimation means refer to the database and further estimate the imaging direction in which the imaging device has taken the image on the basis of the extracted feature information that is extracted by the extraction means.

(Note 3) The information processing system according to note 1 or note 2, wherein

the extraction means discriminates a first image area in which a moving body is imaged from a second image area in which a stationary body is imaged in the imaged image and extracts the feature information only in the second image area.

(Note 4) The information processing system according to any one of notes 1 to 3, wherein

the display means varies a sign of the position on the map of the imaging device that is estimated by the estimation means according to the likelihood of the position on the map of the imaging device that is estimated.

(Note 5) The information processing system according to any one of notes 1 to 4, wherein

the estimation means includes
a comparison means which compares the position on the map and the feature information included in an image which can be taken, and associated with the position that are stored in the database, with the feature information of the imaged image that is extracted by the extraction means and
a vote means which searches for feature information similar to the feature information on the extracted imaged image, votes on the position on the map that is associated with the feature information found by the search and stored, and repeats the voting with respect to all the extracted feature information

and estimates the position on the map of the imaging device depending on the result of voting by the voting means.

(Note 6) The information processing system according to note 5, wherein

the display means varies a sign of the position on the map of the imaging device that is estimated by the estimation means depending on the number of votes.

(Note 7) An information processing method comprising:

a first extraction step of extracting feature information from an image obtained by using an imaging device;

a first estimation step of estimating a position at which the imaging device exists on a map on the basis of the feature information that is extracted in the first extraction step, upon referring to a database which stores the position on the map and feature information in the image which can be taken by the imaging device at the position, to be associated with each other;

a first display step of displaying an estimated current position of the imaging device that is estimated in the first estimation step;

a determination step of determining whether or not an imaging direction of the imaging device is varied by a predetermined amount from a direction in which the image from which the feature information is extracted in the first extraction step is taken during the imaging by the imaging device;

a second extraction step of extracting new feature information when it is determined in the determination step that the imaging direction of the imaging device is varied by the predetermined amount;

a second estimation step of re-estimating the position on the map at which the imaging device exists by combining the new feature information and the extracted feature information when the new feature information is extracted; and

a second display step of displaying the estimated current position of the imaging device that is estimated in the second estimation step.

(Note 8) A program recording medium storing an information processing program which causes a computer to perform, comprising:

a first extraction step of extracting feature information from an image obtained by using an imaging device;

a first estimation step of estimating a position at which the imaging device exists on a map on the basis of the feature information that is extracted in the first extraction step, upon referring to a database which stores the position on the map and feature information in the image which can be taken by the imaging device at the position, to be associated with each other;

a first display step of displaying an estimated current position of the imaging device that is estimated in the first estimation step;

a determination step of determining whether or not an imaging direction of the imaging device is varied by a predetermined amount from a direction in which the image from which the feature information is extracted in the first extraction step is taken during the imaging by the imaging device;

a second extraction step of extracting new feature information when it is determined in the determination step that the imaging direction of the imaging device is varied by the predetermined amount;

a second estimation step of re-estimating the position on the map at which the imaging device exists by combining the new feature information and the extracted feature information when the new feature information is extracted; and

a second display step of displaying the estimated current position of the imaging device that is estimated in the second estimation step.

The invention of the present application has been described above with reference to the exemplary embodiment. However, the invention of the present application is not limited to the above mentioned exemplary embodiment. Various changes in the configuration or details of the invention of the present application that can be understood by those skilled in the art can be made without departing from the scope of the invention.

This application claims priority from Japanese Patent Application 2010-291070 filed on Dec. 27, 2010, the disclosure of which is hereby incorporated by reference in its entirety.

1. An information processing system comprising:
a database which stores a position on a map and feature information in an image which can be taken by an imaging device at the position, to be associated with each other;
an extraction unit which extracts the feature information from imaged image obtained by using the imaging device;
an estimation unit which estimates the position at which the imaging device exists on a map on the basis of the feature information that is extracted in the extraction means, referring to the database;
a display unit which displays an estimated current position of the imaging device that is estimated by the estimation unit;
a determination unit which determines whether or not an imaging direction of the imaging device is varied by a predetermined amount from a direction in which the image from which the feature information is extracted by the extraction means is taken during the imaging by the imaging device; and
a control unit which controls the extraction unit so that new feature information is extracted when the determination unit determines that the imaging direction of the imaging device is varied by the predetermined amount; wherein
the estimation unit combines the new feature information and the extracted feature information and re-estimates the position on the map at which the imaging device exists when the new feature information is extracted.

2. The information processing system according to claim 1, wherein
the database stores the position on the map, a direction centering around the position, and the feature information included in the image which can be taken at the position on the map in the direction viewed from the position, to be associated with each other, and
the estimation unit refer to the database and further estimate the imaging direction in which the imaging device has taken the image on the basis of the extracted feature information that is extracted by the extraction unit.

3. The information processing system according to claim 1, wherein
the extraction unit discriminates a first image area in which a moving body is imaged from a second image area in which a stationary body is imaged in the imaged image and extracts the feature information only in the second image area.

4. The information processing system according to claim 1, wherein
the display unit varies a sign of the position on the map of the imaging device that is estimated by the estimation unit according to the likelihood of the position on the map of the imaging device that is estimated.

5. The information processing system according to claim 1, wherein
the estimation unit includes
a comparison unit which compares the position on the map and the feature information included in an image which can be taken, and associated with the position that are stored in the database, with the feature information of the imaged image that is extracted by the extraction unit and
a vote unit which searches for feature information similar to the feature information on the extracted imaged image, votes on the position on the map that is associated with the feature information found by the search and stored, and repeats the voting with respect to all the extracted feature information
and estimates the position on the map of the imaging device depending on the result of voting by the voting unit.

6. The information processing system according to claim 5, wherein
the display unit varies a sign of the position on the map of the imaging device that is estimated by the estimation unit depending on the number of votes.

7. An information processing method comprising of:
a first extraction step of extracting feature information from an image obtained by using an imaging device;
a first estimation step of estimating a position at which the imaging device exists on a map on the basis of the feature information that is extracted in the first extraction step, upon referring to a database which stores the position on the map and feature information in the image which can be taken by the imaging device at the position, to be associated with each other;
a first display step of displaying an estimated current position of the imaging device that is estimated in the first estimation step;
a determination step of determining whether or not an imaging direction of the imaging device is varied by a predetermined amount from a direction in which the image from which the feature information is extracted in the first extraction step is taken during the imaging by the imaging device;
a second extraction step of extracting new feature information when it is determined in the determination step that the imaging direction of the imaging device is varied by the predetermined amount;
a second estimation step of re-estimating the position on the map at which the imaging device exists by combining the new feature information and the extracted feature information when the new feature information is extracted; and
a second display step of displaying the estimated current position of the imaging device that is estimated in the second estimation step.

8. A program recording medium storing an information processing program which causes a computer to perform, comprising:
a first extraction step of extracting feature information from an image obtained by using an imaging device;
a first estimation step of estimating a position at which the imaging device exists on a map on the basis of the feature information that is extracted in the first extraction step, upon referring to a database which stores the position on the map and feature information in the image which can be taken by the imaging device at the position, to be associated with each other;
a first display step of displaying an estimated current position of the imaging device that is estimated in the first estimation step;
a determination step of determining whether or not an imaging direction of the imaging device is varied by a predetermined amount from a direction in which the image from which the feature information is extracted in the first extraction step is taken during the imaging by the imaging device;
a second extraction step of extracting new feature information when it is determined in the determination step that the imaging direction of the imaging device is varied by the predetermined amount;
a second estimation step of re-estimating the position on the map at which the imaging device exists by combining the new feature information and the extracted feature information when the new feature information is extracted; and
a second display step of displaying the estimated current position of the imaging device that is estimated in the second estimation step.

9. An information processing system comprising:
a database which stores a position on a map and feature information in an image which can be taken by an imaging device at the position, to be associated with each other;
an extraction means for extracting the feature information from imaged image obtained by using the imaging device;
an estimation means for estimating the position at which the imaging device exists on the map on the basis of the feature information that is extracted in the extraction means, referring to the database;
a display means for displaying an estimated current position of the imaging device that is estimated by the estimation means;
a determination means for determining whether or not an imaging direction of the imaging device is varied by a predetermined amount from a direction in which the image from which the feature information is extracted by the extraction means is taken during the imaging by the imaging device; and
a control means for controlling the extraction means so that new feature information is extracted when the determination means determines that the imaging direction of the imaging device is varied by the predetermined amount;
wherein the estimation means combines the new feature information and the extracted feature information and re-estimates the position on the map at which the imaging device exists when the new feature information is extracted.
